(19) United States
(12) Patent Application Publication
(10) Pub. No.: US 2015/0181381 A1
(43) Pub. Date: Jun. 25, 2015

(54) METHOD AND APPARATUS FOR TIME OF FLIGHT FINGERPRINT AND GEO-LOCATION

(71) Applicants: Gaby Prechner, Rishon Lezion (IL); Yuval Amizur, Kfar Saba (IL)

(72) Inventors: Gaby Prechner, Rishon Lezion (IL); Yuval Amizur, Kfar Saba (IL)

(21) Appl. No.: 14/127,257

(22) PCT Filed: Oct. 17, 2013
(86) PCT No.: PCT/US2013/065414

§ 371 Date: Dec. 18, 2013

(51) Int. Cl. H04W 4/02; H04W 64/00

(52) U.S. Cl. CPC H04W 4/021; H04W 64/00

(57) ABSTRACT

The disclosure relates to locating a device in an environment. In one embodiment, the disclosure is directed to a method to determine a device location. The method includes receiving a signal from the device at a receiver circuit and determining the device location by comparing the signal attribute with a Time-of-Flight (ToF) fingerprint map of an environment in which the device is located.

The disclosure claims the filing date benefit of PCT Application No. PCT/U.S. Ser. No. 13/065414, filed Oct. 17, 2013, the specification of which is incorporated herein in its entirety.

### BACKGROUND

1. Field

The disclosure relates to a method and apparatus for indoor geo-location. More specifically, the disclosure relates to a method and apparatus for determining indoor location as a function of the indoor environment's fingerprint and the real-time Time-of-Flight (ToF) measurement(s).

2. Description of Related Art

Locating people, animals and mobile terminals inside a structure is becoming more important. The structure can be a covered structure inaccessible by conventional Global Positioning Systems (GPS). Conventional indoor geo-location techniques rely on information including received signal strength indication (RSSI), angle of arrive (AOA), time of arrival (TOA) and time differences of arrival (TDOA). The signal information is then manipulated to determine transmitter location inside a structure or to compile a so-called structure fingerprint.

Conventional techniques provide only limited location accuracy, as they depend largely on Line of Sight (LOS) to ensure accuracy. Complex structures include multi-level structures which produce echo and excessive multi-path propagation, thereby making conventional LOS measurements inaccurate. Because LOS is notoriously unavailable in indoor environments, conventional techniques are subject to high levels of inaccuracy.

A key disadvantage of the RSSI fingerprint is the sensitivity to transmitter power of the access point (AP), orientation and height of the transmitter device and fast fading, all of which can cause variation in the fingerprint map. To overcome inaccuracy, the RSSI fingerprint accuracy is enhanced by providing more AP locations and/or creating a larger database of different points of the structure. Accordingly, there is a need for a method and apparatus to accurately determine the location of a transmitter device within an indoor environment.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows an exemplary ToF fingerprint map;

FIG. 2 illustrates a communication system having an AP and multiple STAs;

FIG. 3A shows the cumulative distribution function for dominant line of sight of an exemplary environment;

FIG. 3B shows the cumulative distribution function for non-dominant line of sight of an exemplary environment;

FIG. 4 is a flow-diagram for determining location of an STA according to one embodiment of the disclosure;

FIG. 5 shows an exemplary coarse location for an STA;

FIG. 6 shows an exemplary device for implementing an embodiment of the disclosure; and

FIG. 7 schematically illustrates an embodiment of the disclosure for determining device location.

### DESCRIPTION

An embodiment of the disclosure relates to a method for detecting a device location in an enclosed environment. The enclosed environment may be covered or uncovered space. The location determination can be done by a mobile device (one which is seeking its location) or it can be sent to another device (another mobile, a server or an access point) for determination.

In one embodiment of the disclosure, the mobile device makes a real-time Time-of-Flight (ToF) measurement. ToF is defined as the overall time a signal propagates from a user to an AP and back to the user. This value can be converted into distance by dividing the time by two and multiplying it by the speed of light. This method can be implemented at the mobile device or at an external location. Once the real-time ToF measurement is obtained, it can be matched to an existing ToF fingerprint Map. The ToF fingerprint map can be created by surveying the area of interest and collecting signal/distance measurement. The ToF can also be created by crowd-sourcing. A device interested in determining its location can search for the best match (e.g., closest location) on the ToF fingerprint map. Finally, the mobile device's location can be added to the ToF fingerprint map to further develop the map. The map can be stored at the mobile device, at an external resource or both. Optionally, the mobile device may initially determine a coarse location and then proceed to determining a substantially exact location.

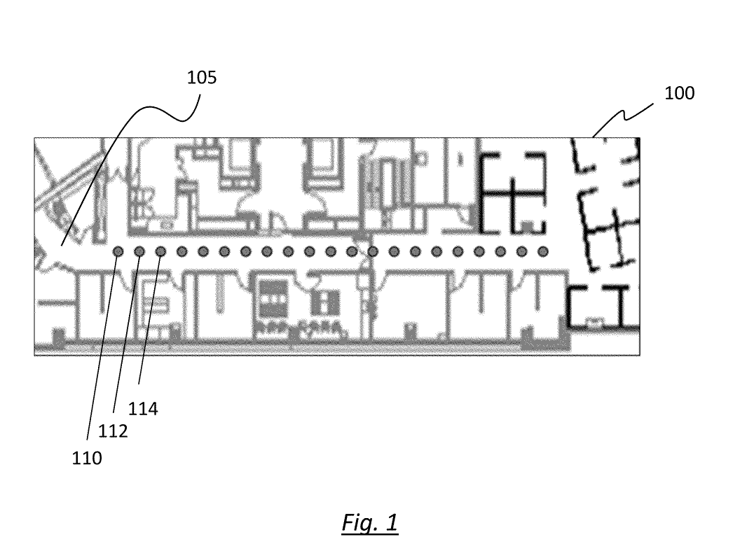

FIG. 1 shows an exemplary ToF fingerprint map. Specifically, the FIG. 1 shows structure 100 having multiple rooms, corridor 105 and other structural features including doors, tables, sinks, etc. A plurality of points are identified on corridor 105. For ease of reference, the first three of the point are identified as 110, 112 and 114. Each point represents a location on structural map 100 where the signal fingerprint is obtained. Each point in the map is also represented by the coordinates of the point, AP's MAC address and average range from each AP.

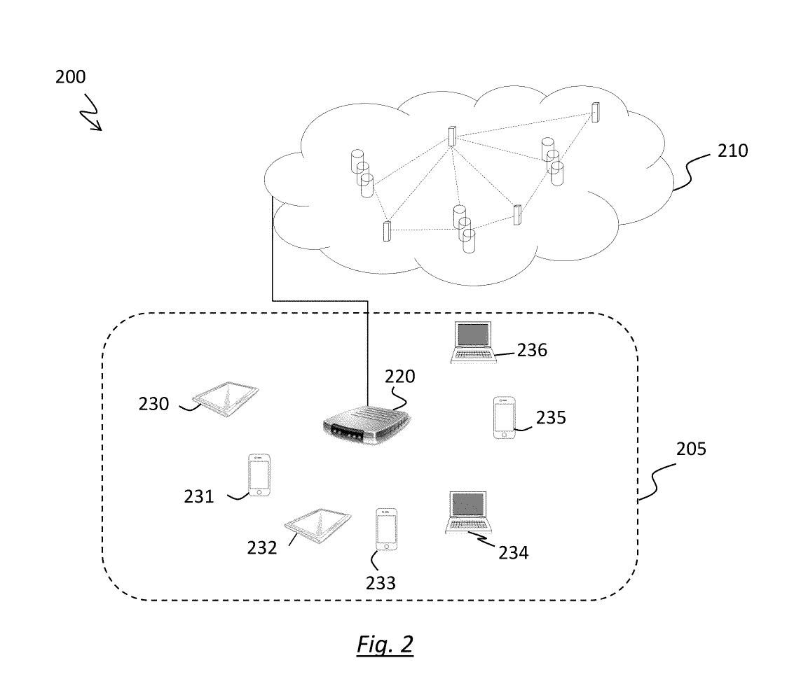

FIG. 2 illustrates a communication system having an AP and multiple STAs. Network 200 of FIG. 2 may include a local wireless LAN (WLAN). Router 220 communicates with the internet backbone 210 and acts as the local AP for structure 205. Structure 205 can define a structural environment including a covered building (e.g., a hospital building), an open space (e.g., a stadium) or a combination of both (e.g., a university campus). Structure 205 is shown as a rectangle for simplicity; however, the structure can have features such as those shown in structural map 100 of FIG. 1. AP 220 communicates with each of STAs 230, 231, 232, 233, 234, 235 and 236. Exemplary STAs include smartphones, laptops, tablets or any other device capable of signal communication with AP 220. The STAs can be within dominant (direct) line-of-sight (DLOS) or non-dominant (indirect) line-of-sight (NDLOS) of AP 220.

Referring to FIG. 1, the distance between the location readout at points 110, 112 and 114 poses a tradeoff between the desired accuracy and database size. If the readout points are very close to each other, location estimation will enjoy a higher degree of accuracy. However, the database will be significantly larger to accommodate the relatively large number of points and locations. Larger databases require more storage space thereby making storage at a local router unfeasible. Larger databases will also have a longer query time thereby making the calculation more time consuming.

Experimental data shows that the average distance between two points has to be between 2-4 m to accurately distinguish the points. That is, the deviation of a range measurement below 2 meters will cause the location points to appear substantially co-located. The deviation is a function of the structural environment and the number of APs deployed within the structure.

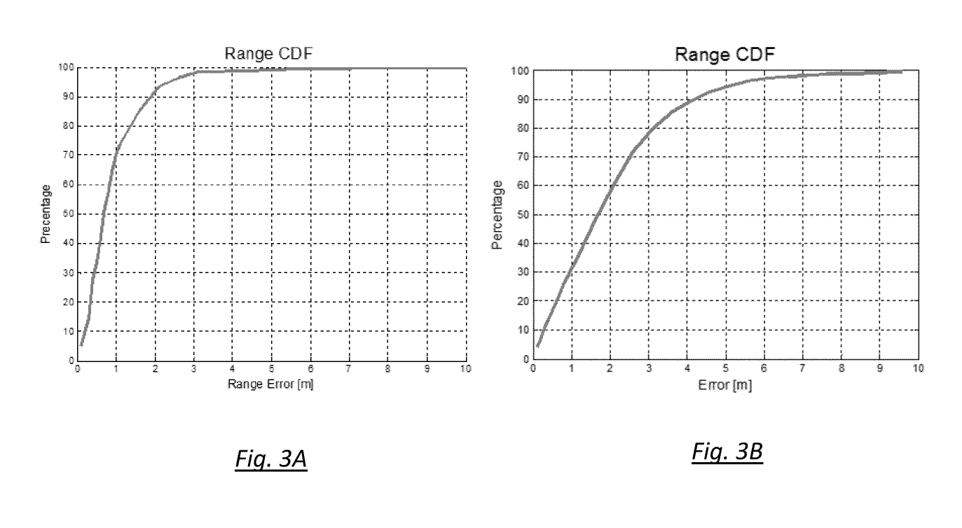

FIG. 3A shows the cumulative distribution function for DLOS of an exemplary environment. The exemplary environment of FIG. 3A can be an enclosed structure similar to that shown in FIG. 1. The data was collected from one or more STAs signaling an AP. The range error was obtained for each transmission and plotted. As can be seen from FIG. 3A, the cumulative distribution function (CDF) for the range is just over 90% at about 2 m. That is, when location points are more than 2 m apart, the accuracy is above 90%.

FIG. 3B shows the cumulative distribution function for NDLOS of an exemplary environment. The exemplary environment of FIG. 3B is similar to that of FIG. 3A. FIG. 3B shows CDF of about 90% for ranges of 4 m or greater. That is, when the location points are more than 4 m apart, the accuracy is above 90%. FIGS. 3A and 3B show that accuracy can be over 90% when locations 110, 112, 114 (FIG. 1) are about 2-4 m apart. As stated, the distance between measurement locations 110, 112 and 114 creates a tradeoff. Small measurement distances (e.g., 4 m) provide a high accuracy for the ToF fingerprint map. However, the small measurement distances also necessitate significantly higher number of measurements creating a significantly larger database.

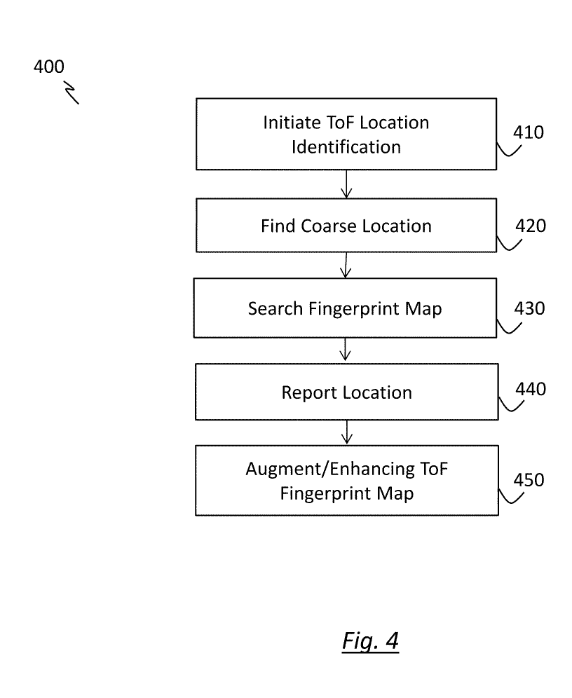

FIG. 4 is a flow-diagram for determining location of an STA according to one embodiment of the disclosure. Process 400 starts at step 410 when an STA makes a location inquiry. The location inquiry can be made when an STA transmits a signal to the surrounding AP. The signal may be any signal and need not be a location inquiry signal. The signals may be part of a routine identification signal transmitted by the STA or it can be a real-time location inquiry. The STA signal initiates the ToF fine measurement process.

At step 420 a coarse location is determined for the STA. The coarse location can be a function of the signal received from the STA. Conventional methods for determining coarse location (e.g., TOA, TDOA, RSSI) can be employed for determining the general location of the STA. Conventional geo-location methods may also be used to determine coarse location. While the coarse location step is optional, it can reduce the computational requirement of map matching or final position fine-tuning.

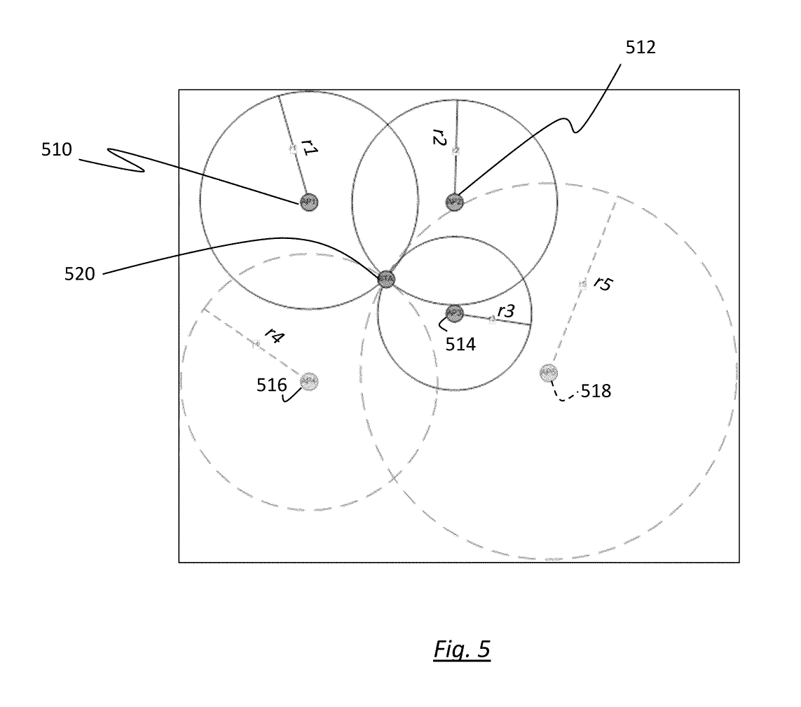

FIG. 5 shows an exemplary coarse location for an STA. Specifically, FIG. 5 shows a trilateration technique used to generally locate STA 520. Each of AP 510 (AP1), 512 (AP2) and 514 (AP3) is within communication range of STA 520. While APs 516 and 518 are also within STA's communication range, only the three closest APs are needed. The distance between STA 520 and each of AP 510, 512 and 514 is shown as r1, r2 and r3, respectively. The distance between STA 520 and APs 516 and 518 is shown as r4 and r5, respectively. FIG. 5 shows the relationship: r5>r4>r1>r2>r3. Using conventional trilateration techniques and the distances r1, r2 and r3, a coarse location for STA 520 can be calculated.

Referring once again to FIG. 4, the coarse location of STA 520 (FIG. 5) is used to expedite ToF fingerprint map. The ToF fingerprint map can be generated apriori for the environment under study. At step 430, the coarse location of step 430 is used to identify locations on the ToF fingerprint map that are closest to the coarse location. If the coarse location is identical to a known location on the ToF fingerprint map, then the 520 is assumed to be co-located with the known location on the ToF fingerprint map. If the coarse location is not identical to any known location on the ToF fingerprint map, then additional calculation may be necessary to approximate the exact location of STA 520 as a function of the closest known locations on ToF fingerprint map.

Absent a known coarse location, the exact location of STA 520 can be determined as a function of one more of APs within detection range. That is, once the closest AP (or any AP) is identified, the ToF fingerprint map can be used to identify locations with similar RSSI. while identifying a large area as for as the coarse location may be easier, defining a smaller area will enable faster fingerprint map search.

At step 440 the exact (or fine) location of STA 520 is reported to the STA or any other source. Finally, at step 450 the newly-found STA location and its attributes may be optionally added to the ToF fingerprint map in order to further enhance, update and develop the map database.

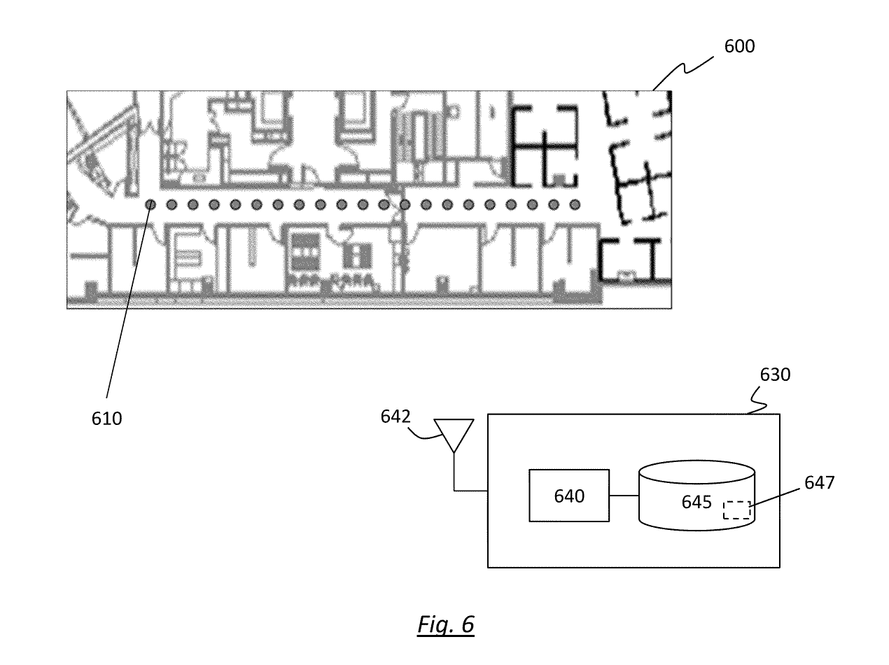

The steps of flow-diagram 400 may be implemented in a smartphone or other handheld devices or at any other processor-based device. These steps may also be implemented at an AP. FIG. 6 shows an exemplary device for implementing an embodiment of the disclosure. Specifically, FIG. 6 shows environment 600 having STA 610 moving along a path. STA 610 communicates with AP 630. AP 630 can be a router, a peer device or any other device capable of receiving and registering communication signal from STA 610. Exemplary AP 630 is shown with antenna 642, processor circuitry 640 and database circuitry 645. AP 630 may include additional transceiver components such as front-end receiver components or dedicated geo-location processor. Although not shown, device 630 may be connected to a WLAN or the internet backbone.

Upon receiving an incoming signal from STA 610, the signal is processed and directed to processor circuitry 640. Memory circuitry 645 includes instructions which engage the processor to receive and register one or more signals from STA 610. The processor circuitry 640 then estimates a coarse location for the STA. The coarse location may be considered as the first location. As stated, this determination can be made as a function of trilateration or other known methods. Next, the processor accesses ToF fingerprint map file 647 stored at memory circuitry 645. ToF fingerprint map file 647 contains a map of environment 600. The map may constitute a structural or architectural map. File 647 may also include several different maps containing different information accessible to processor 640. Accessing file 647, processor circuitry 640 identifies one or more locations from the ToF fingerprint map proximal to the first location. If the signal attributes lead to an exact location determination, then the processor merely reports or stores the location of STA 530. If the signal attributes of STA 610 do not match with an exact location on the ToF fingerprint map, then processor circuitry 640 calculates an exact location for STA 610 based on the signal information and known locations on the ToF fingerprint map.

Processor 640 may report the calculated location or may store the information at memory circuitry 645. File 647 may also be updated to include location calculated for STA 610 and its corresponding signal attributes. It should be noted that while FIG. 6 shows AP 630 as an AP, the same circuitry (processor and memory) may be used at STA 610 to conduct the same location inquiry at the STA.

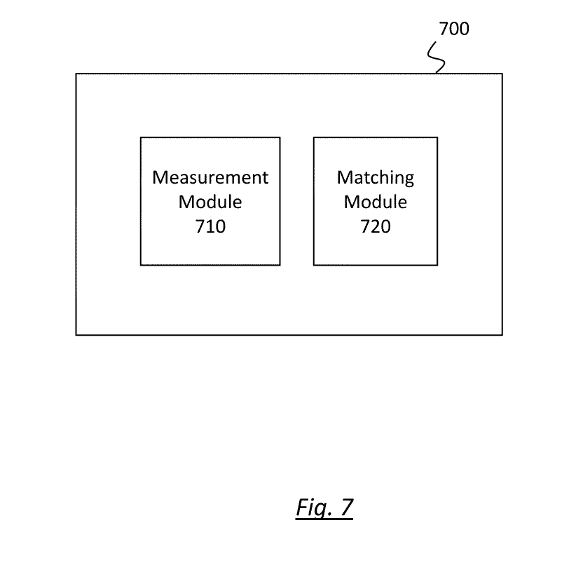

FIG. 7 schematically illustrates an embodiment of the disclosure for determining device location. FIG. 7 shows device 700 which can be an integral part of a larger system or can be a stand-alone unit. For example, device 700 can define a system on chip configured to implement the disclosed methods. Device 700 may be part of a larger system having multiple antennas a radio and a memory system. Device 700 includes measurement module 710 and matching module 720. Modules 710 and 720 can be hardware, software or a combination of hardware and software. In an exemplary embodiment, at least one of modules 710 or 720 includes a processor circuit and a memory circuit communicating with each other.

In an exemplary embodiment, measurement module 720 is configured to obtain a ToF measurement with respect to another device. The other device can be another mobile device, an APA, a server or a base station. In an embodiment, matching module 720 is configured to match the ToF measurement with a ToF fingerprint map and identify a device location by matching the ToF measurement with the ToF fingerprint map. The location may be coarse location or a substantially exact location. In an exemplary embodiment, a substantially exact location is within 10 m of the device's actual location. In another example embodiment, a substantially exact location is within 4 m of the device's actual location. In still another exemplary embodiment, a substantially exact location is within 2 m of the device's actual location.

The following examples pertain to further embodiments. Example 1 includes a method to determine a device location, the method comprising: receiving a signal from the device at a receiver circuit and determining the device location by comparing the signal attribute with a Time-of-Flight (ToF) fingerprint map of an environment in which the device is located.

Example 2 includes the method of example 1, wherein the signal attribute further comprises one or more of Time-of-Flight, received signal strength information (RSSI), time-of-arrival (TOA) or time-difference-of-arrival (TDOA) for the signal.

Example 3 includes the method of example 1, further comprising determining a coarse device location.

Example 4 includes the method of example 1, wherein the environment is an enclosed environment.

Example 5 includes the method of any of examples 1-4, wherein comparing the signal attribute with a Time-of-Flight (ToF) fingerprint map further comprises identifying at least one location on the ToF map with similar signal attributes.

Example 6 includes, the method of example 1, further comprising determining at least one of a longitude, a latitude and an altitude of the device location.

Example 7 includes the method of any of examples 1-6, wherein the device is a mobile device.

Example 8 includes an apparatus comprising means for performing the method of examples 1-7.

Example 9 includes a tangible machine readable storage medium including machine-readable instructions, which, if executed, implement a method or realize an apparatus as disclosed in any of examples 1-7.

Example 10 includes a device comprising: a measurement module to obtain a Time-of-Flight (ToF) measurement with respect to another device; and a matching module to match the Time-of-Flight measurement with a ToF fingerprint map and to identify a device location by matching the ToF measurement with a location on the ToF fingerprint map.

Example 11 includes the device of any of examples 10, wherein the processor further determines at least one of a longitude, a latitude and an altitude of the substantially exact location.

Example 12 includes the device of any of examples 10-11, wherein the ToF fingerprint map includes location information for the enclosed environment.

Example 13 includes the device of any of examples 10-12, wherein the device is a mobile device.

Example 14 includes the device of example 10, wherein the matching module is further configured to identify a coarse location.

Example 15 includes the device of example 14, wherein the matching module is further configured to identify a coarse location as a function of the ToF measurement

Example 16 includes the device of any of examples 10-15, wherein the ToF fingerprint map further comprises a structural map of the environment.

Example 17 includes the device of any of examples 10-15, wherein the ToF fingerprint map comprises a plurality of previously identified locations that are not less than 4 m apart.

Example 18 includes the device of any of examples 10-16, wherein the ToF fingerprint map comprises a plurality of previously identified locations that are about 2-4 m apart.

Example 19 includes a geo-location device for locating a device inside a structure, the geo-location device comprising: means for receiving a signal from an access point at a first location in the environment; means for identifying a coarse coordinates for the first location; means for accessing a database containing a Time-of-Flight (ToF) fingerprint map of the structure; means for identifying a second location from the ToF fingerprint map, the second location identifying a substantially exact location for the device within the environment as a function of the first location and the coarse coordinates.

Example 20 includes the geo-location device of example 19, wherein the ToF fingerprint map comprises location estimates that are about 2-4 m apart.

Example 21 includes the geo-location device of examples 19 or 20, further comprising means for transmitting the exact location.

Example 22 includes a geo-location system, comprising: one or more antennas; a radio; a memory circuit; a processor circuit to calculate a Time-of-Flight (ToF) measurement and to match the ToF measurement with a ToF fingerprint map to identify a device location.

Example 23 includes the geo-location system of example 22, wherein the memory circuit further comprises the ToF fingerprint map.

Example 24 includes the geo-location system of example 22, wherein the processor circuit is configured to communicate with the memory circuit and the memory circuit contains instructions for the processor circuit to identify a coarse coordinates for the device.

Example 25 includes the geo-location system of example 22, wherein the processor circuit is configured to communicate with the memory circuit and the memory circuit contains instructions to access a database in the memory circuit containing a Time-of-Flight (ToF) fingerprint map.

While the principles of the disclosure have been illustrated in relation to the exemplary embodiments shown herein, the principles of the disclosure are not limited thereto and include any modification, variation or permutation thereof.

1-25. (canceled)

26. A method to determine a device location, the method comprising: receiving a signal from the device at a receiver circuit and determining the device location by comparing the signal attribute with a Time-of-Flight (ToF) fingerprint map of an environment in which the device is located.

27. The method of claim 26, wherein the signal attribute further comprises one or more of Time-of-Flight, received signal strength information (RSSI), time-of-arrival (TOA) or time-difference-of-arrival (TDOA) for the signal.

28. The method of claim 26, further comprising determining a coarse device location.

29. The method of claim 26, wherein the environment is an enclosed environment.

30. The method of claim 26, wherein comparing the signal attribute with a Time-of-Flight (ToF) fingerprint map further comprises identifying at least one location on the ToF map with similar signal attributes.

31. The method of claim 26, further comprising determining at least one of a longitude, a latitude and an altitude of the device location.

32. The method of claims 26, wherein the device is a mobile device.

33. An apparatus comprising means for performing the method of claim 26.

34. A tangible machine readable storage medium including machine-readable instructions, which, if executed, implement a method or realize an apparatus as claimed in claim 26.

35. A device comprising:
a measurement module to obtain a Time-of-Flight (ToF) measurement with respect to another device; and
a matching module to match the Time-of-Flight measurement with a ToF fingerprint map and to identify a device location by matching the ToF measurement with a location on the ToF fingerprint map.

36. The device of any of claims 35, wherein the processor further determines at least one of a longitude, a latitude and an altitude of the substantially exact location.

37. The device of claim 35, wherein the ToF fingerprint map includes location information for the enclosed environment.

38. The device of claim 35, wherein the device is a mobile device.

39. The device of claim 35, wherein the matching module is further configured to identify a coarse location.

40. The device of claim 39, wherein the matching module is further configured to identify a coarse location as a function of the ToF measurement

41. The device of claims 35, wherein the ToF fingerprint map further comprises a structural map of the environment.

42. The device of claim 35, wherein the ToF fingerprint map comprises a plurality of previously identified locations that are not less than 4 m apart.

43. The device of claim 35, wherein the ToF fingerprint map comprises a plurality of previously identified locations that are about 2-4 m apart.

44. A geo-location device for locating a device inside a structure, the geo-location device comprising:
means for receiving a signal from an access point at a first location in the environment;
means for identifying a coarse coordinates for the first location;
means for accessing a database containing a Time-of-Flight (ToF) fingerprint map of the structure;
means for identifying a second location from the ToF fingerprint map, the second location identifying a substantially exact location for the device within the environment as a function of the first location and the coarse coordinates.

45. The geo-location device of claim 44, wherein the ToF fingerprint map comprises location estimates that are about 2-4 m apart.

46. The geo-location device of claim 44, further comprising means for transmitting the exact location.

47. A geo-location system, comprising:
one or more antennas;
a radio;
a memory circuit;
a processor circuit to calculate a Time-of-Flight (ToF) measurement and to match the ToF measurement with a ToF fingerprint map to identify a device location.

48. The geo-location system of claim 47, wherein the memory circuit further comprises the ToF fingerprint map.

49. The geo-location system of claim 47, wherein the processor circuit is configured to communicate with the memory circuit and the memory circuit contains instructions for the processor circuit to identify a coarse coordinates for the device.

50. The geo-location system of claim 47, wherein the processor circuit is configured to communicate with the memory circuit and the memory circuit contains instructions to access a database in the memory circuit containing a Time-of-Flight (ToF) fingerprint map.
